(19) United States
(12) Patent Application Publication
(10) Pub. No.: US 2019/0004309 A1
(43) Pub. Date: Jan. 3, 2019

(54) HOUSING AND HOUSING UNIT

(71) Applicant: Nidec Corporation, Kyoto (JP)

(72) Inventors: Takeyuki SHUTO, Kyoto (JP); Yoichi SEKII, Kyoto (JP)

(21) Appl. No.: 15/946,738

(22) Filed: Apr. 6, 2018

(30) Foreign Application Priority Data
Jun. 29, 2017 (JP) 2017-127107

(51) Int. Cl. G02B 26/08

(52) U.S. Cl. CPC G02B 26/0816

(57) ABSTRACT

This housing is arranged to house therein at least a portion of an optical component and at least a portion of a rotary drive apparatus includes a motor arranged to rotate the optical component. The optical component is arranged to reflect incoming light coming from a light source or allow the incoming light to pass therethrough. The housing includes at least one tubular portion extending along a central axis extending in a vertical direction. The housing includes, at at least one axial position, one or more light source positioning portions each of which is arranged to be in contact with the light source in at least one of an axial direction, a radial direction, and a circumferential direction; and one or more motor positioning portions each of which is arranged to be in contact with the motor in at least one of the axial direction, the radial direction, and the circumferential direction. The housing is defined by a single monolithic member including the one or more light source positioning portions and the one or more motor positioning portions. A cavity radially inside of the housing includes a light path along which the incoming light travels.

### CROSS REFERENCE TO RELATED APPLICATIONS

This application claims the benefit of priority to Japanese Patent Application No. 2017-127107 filed on Jun. 29, 2017. The entire contents of this application are hereby incorporated herein by reference.

### BACKGROUND OF THE INVENTION

### 1. Field of the Invention

The present invention relates to a housing and a housing unit.

### 2. Description of the Related Art

A known scanner apparatus used for position recognition in a head-mounted display (HMD) or the like typically has installed therein a light source, an optical component, such as a mirror, arranged to reflect incoming light coming from the light source, and a motor including a rotor arranged to support the optical component. A known apparatus arranged to rotate an optical component is described in, for example, JP-A 1998-274527.

### SUMMARY OF THE INVENTION

A distance measuring apparatus described in JP-A 1998-274527 includes a casing which defines an outer frame thereof. A hollow motor including a rotor arranged to hold a transmission mirror and a focusing mirror, a laser beam transmission means, a light receiving sensor for distance detection, and so on are housed in the casing. The laser beam transmission means is arranged to transmit laser beams (i.e., transmission laser beams) onto an axis of the rotor. The transmission mirror is arranged on a rotation axis of the rotor of the hollow motor to cause the laser beams transmitted from the laser beam transmission means to be reflected in a direction inclined with respect to the rotation axis. The focusing mirror is arranged to receive the laser beams reflected by a target object the distance to which is to be measured, and reflect the laser beams toward the light receiving sensor. Thus, rotation of the rotor causes the transmission laser beams to be continuously transmitted in a circular pattern to enable a detailed measurement of an uneven portion of the target object.

However, in the distance measuring apparatus described in JP-A 1998-274527, each of the transmission mirror, the focusing mirror, the hollow motor, the laser beam transmission means, the light receiving sensor, and so on is separately positioned and fixed in the casing. Thus, the number of parts for positioning and fixing is increased, and this may cause an increased cost. In addition, an assembling process is complicated, which may lead to a reduction in manufacturing efficiency. Further, depending on the precision in arrangement of various parts, the position of each mirror relative to the target object and the angle of the laser beams may change, affecting measured values.

The present invention has been conceived to provide a structure in which a light source and a motor, which may be arranged to rotate a flywheel arranged to support an optical component, are positioned using a housing defined by a single monolithic member to achieve a reduced cost and increased manufacturing efficiency. The present invention has also been conceived to provide a structure that is able to reduce the likelihood of a displacement of incoming light coming from a light source and of a displacement of an optical component.

A housing according to a preferred embodiment of the present invention is arranged to house therein at least a portion of an optical component and at least a portion of a rotary drive apparatus. The optical component is arranged to reflect incoming light coming from a light source or allow the incoming light to pass therethrough. The rotary drive apparatus includes a motor arranged to rotate the optical component. The housing includes at least one tubular portion extending along a central axis extending in a vertical direction. The housing includes, at at least one axial position, one or more light source positioning portions each of which is arranged to be in contact with the light source in at least one of an axial direction, a radial direction, and a circumferential direction; and one or more motor positioning portions each of which is arranged to be in contact with the motor in at least one of the axial direction, the radial direction, and the circumferential direction. The housing is defined by a single monolithic member including the one or more light source positioning portions and the one or more motor positioning portions. A cavity radially inside of the housing includes a light path along which the incoming light travels.

According to the above preferred embodiment of the present invention, the light source and the motor, which may be arranged to rotate a flywheel arranged to support the optical component, are positioned using the housing defined by a single monolithic member. Thus, a reduced number of parts and a reduced cost can be achieved. In addition, an improvement in workability in assembling and increased manufacturing efficiency can be achieved. Further, a reduction in the likelihood of a displacement of the incoming light coming from the light source and of a displacement of the optical component can be achieved, resulting in an increased product reliability.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of a housing unit according to a first preferred embodiment of the present invention.

FIG. 2 is a vertical sectional view of the housing unit according to the first preferred embodiment.

FIG. 3 is a vertical sectional view of the housing unit according to the first preferred embodiment.

FIG. 4 is a vertical sectional view of a housing according to the first preferred embodiment.

FIG. 5 is a top view of a base portion according to the first preferred embodiment.

FIG. 6 is a horizontal sectional view of a light source and a first tubular portion according to a modification of the first preferred embodiment.

FIG. 7 is a partial vertical sectional view of a housing unit according to another modification of the first preferred embodiment.

FIG. 8 is a vertical sectional view of a housing unit according to yet another modification of the first preferred embodiment.

FIG. 9 is a partial vertical sectional view of a housing unit according to yet another modification of the first preferred embodiment.

FIG. 10 is a vertical sectional view of a housing unit according to yet another modification of the first preferred embodiment.

### DETAILED DESCRIPTION OF THE PREFERRED EMBODIMENTS

Hereinafter, preferred embodiments of the present invention will be described with reference to the accompanying drawings. It is assumed herein that a direction parallel to a central axis of a motor, which will be described below, is referred to by the term “axial direction”, “axial”, or “axially”, that directions perpendicular to the central axis of the motor are each referred to by the term “radial direction”, “radial”, or “radially”, and that a direction along a circular arc centered on the central axis of the motor is referred to by the term “circumferential direction”, “circumferential”, or “circumferentially”. It is also assumed herein that an axial direction is a vertical direction, and that a side on which a light source is arranged with respect to the motor is defined as an upper side. The shape of each member or portion and relative positions of different members or portions will be described based on the above assumptions. It should be noted, however, that the above definitions of the vertical direction and the upper and lower sides are not meant to restrict in any way the orientation of a housing or a housing unit according to any preferred embodiment of the present invention when in use. Also note that the term “parallel” as used herein includes both “parallel” and “substantially parallel”. Also note that the term “perpendicular” as used herein includes both “perpendicular” and “substantially perpendicular”.

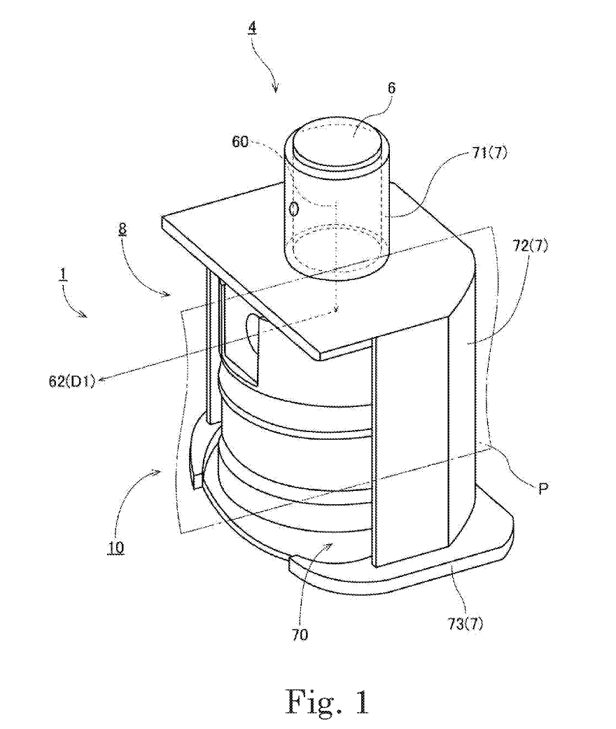

FIG. 1 is a perspective view of a housing unit 4 according to a first preferred embodiment of the present invention. Referring to FIG. 1, the housing unit 4 includes a rotary drive apparatus 1, a light source 6, and a housing 7. At least a portion of the rotary drive apparatus 1 is housed in the housing 7.

The rotary drive apparatus 1 is an apparatus arranged to rotate optical components 90 each of which is arranged to cause incoming light 60 coming from the light source 6 to be reflected in a radial direction (i.e., a first radial direction D1), or allow the incoming light 60 to pass therethrough, and to emit reflected light 62 to an outside of the rotary drive apparatus 1 while rotating the optical components 90. The optical components 90 will be described below. The light source 6 is arranged above the rotary drive apparatus 1. At least a portion of the light source 6 is arranged on a central axis 9 of a motor 10, which will be described below. The incoming light 60, which travels downward along the central axis 9, is emitted from the light source 6. In the present preferred embodiment, at least a portion of the light source 6 is housed in the housing 7, and is fixed to a first tubular portion 71, which will be described below, of the housing 7. Details thereof will be described below.

The rotary drive apparatus 1 includes the motor 10, a flywheel 8, and the optical components 90, which will be described below.

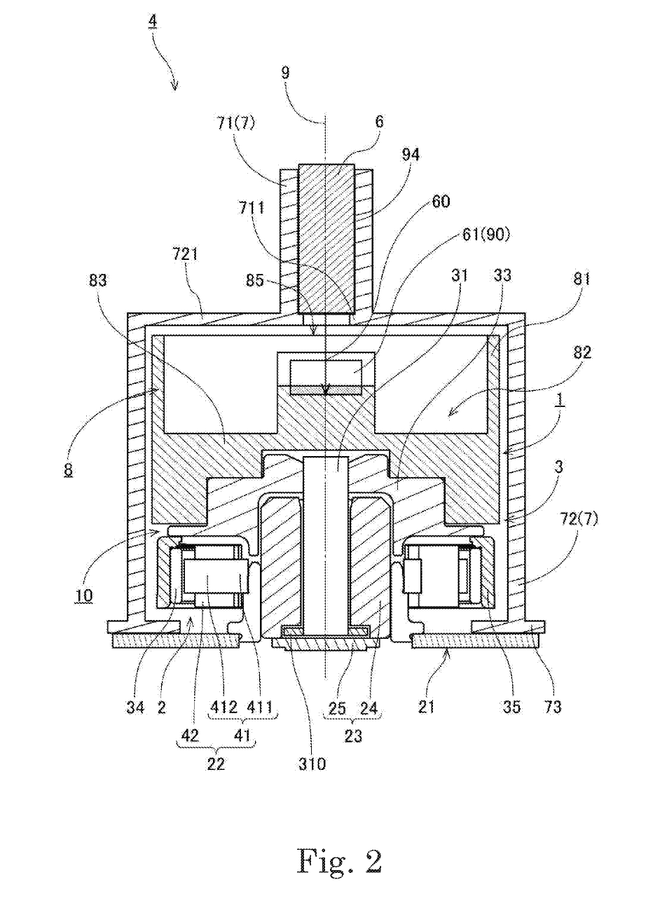

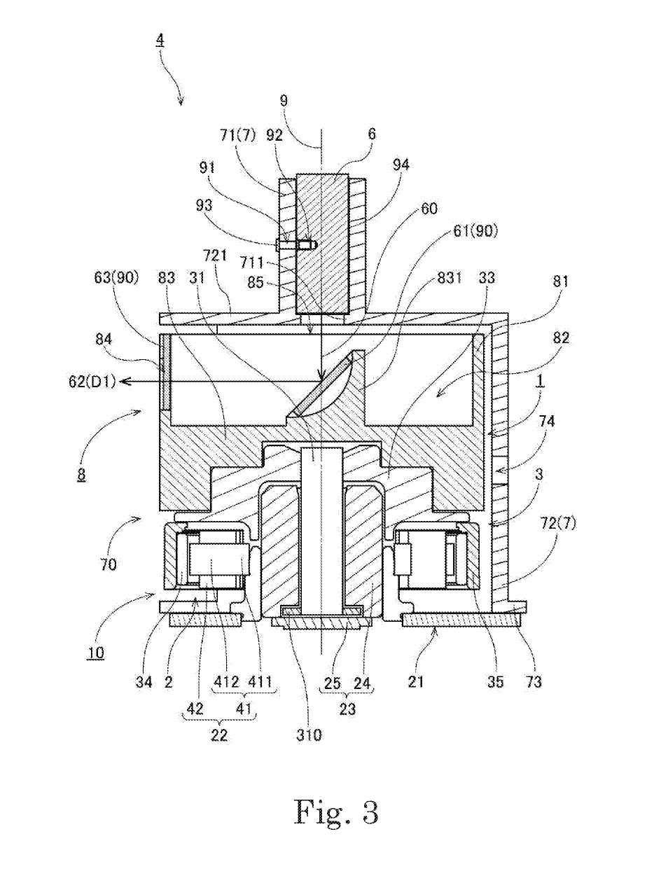

First, the structure of the motor 10 will now be described below. FIG. 2 is a vertical sectional view of the housing unit 4 according to the first preferred embodiment. FIG. 3 is a vertical sectional view of the housing unit 4 according to the first preferred embodiment taken along a plane different from that of FIG. 2.

Referring to FIGS. 2 and 3, the motor 10 includes a stationary portion 2 and a rotating portion 3. The stationary portion 2 is arranged to be stationary relative to the housing 7, in which the rotary drive apparatus 1 is housed. In addition, the stationary portion 2 is fixed to the housing 7. The rotating portion 3 is supported to be rotatable about the central axis 9, which extends in the vertical direction, with respect to the stationary portion 2.

The stationary portion 2 according to the present preferred embodiment includes a base portion 21, a stator 22, and a bearing 23 arranged to rotatably support a shaft 31, which will be described below. Further, the base portion 21 includes one or more recessed portions 210 each of which is recessed downward from a portion of an upper surface of the base portion 21. The recessed portion(s) 210 will be described in detail below.

The stator 22 is an armature including a stator core 41 and a plurality of coils 42. The stator core 41 is, for example, defined by laminated steel sheets, that is, electromagnetic steel sheets, such as, for example, silicon steel sheets, placed one upon another in the axial direction. The stator core 41 is fixed to at least a portion of the base portion 21 through, for example, an adhesive. The stator 22 is thus held by the base portion 21. In addition, the stator core 41 includes a core back 411 in the shape of a circular ring, and a plurality of teeth 412 arranged to project radially outward from the core back 411. The coils 42 are a collection of conducting wires wound around the teeth 412. The teeth 412 and the coils 42 are arranged in an annular shape with the central axis 9 as a center.

The bearing 23 includes a sleeve 24 arranged to extend in the axial direction to assume a substantially cylindrical shape around the shaft 31, and a disk-shaped cap 25 arranged to close an opening at a lower end of the sleeve 24. An inner circumferential surface of the sleeve 24 is arranged radially opposite to an outer circumferential surface of the shaft 31.

The rotating portion 3 according to the present preferred embodiment includes the shaft 31, a rotor hub 33, a magnet 34, and a yoke 35.

The shaft 31 is a columnar member arranged to extend in the axial direction along the central axis 9. The shaft 31 may be defined integrally with the rotor hub 33 or be defined by a member separate from the rotor hub 33. A metal, such as stainless steel, for example, is used as a material of the shaft 31. The outer circumferential surface of the shaft 31 and the inner circumferential surface of the sleeve 24 are arranged radially opposite to each other with a slight gap therebetween. In addition, a disk-shaped shaft annular portion 310, which is arranged to extend radially outward from a lower end of the shaft 31, is fixed to a lower portion of the shaft 31. An upper surface of the shaft annular portion 310 and a lower surface of the sleeve 24 are arranged axially opposite to each other with a slight gap therebetween. In addition, a lower surface of the shaft annular portion 310 and an upper surface of the cap 25 are arranged axially opposite to each other with a slight gap therebetween. Note that the shaft 31 and the shaft annular portion 310 may alternatively be defined by a single monolithic member. The above gaps are arranged to be continuous with each other, and a lubricating fluid is continuously arranged in the gaps. The shaft 31 is supported to be rotatable with respect to the sleeve 24 and the cap 25 with the gaps including the lubricating fluid therebetween, and is arranged to rotate about the central axis 9 while the motor 10 is running. That is, in the present preferred embodiment, the bearing 23, which is a fluid dynamic bearing, is defined by the sleeve 24 and the cap 25, which belong to the stationary portion 2, the shaft 31, which belongs to the rotating portion 3, and the lubricating fluid arranged therebetween. A lubricating liquid, such as a polyolester oil or a diester oil, for example, is used as the lubricating fluid. An upper end portion of the shaft 31 is arranged to project upward above an upper surface of the sleeve 24. Note that, instead of the fluid dynamic bearing, a bearing of another type, such as, for example, a rolling-element bearing, may alternatively be used in the motor 10.

The rotor hub 33 is a member arranged to extend in an annular shape around the central axis 9. In the motor 10 according to the present preferred embodiment, the shaft 31 and the rotor hub 33 are fixed to each other through press fitting and an adhesive. Note, however, that the shaft 31 and the rotor hub 33 may alternatively be fixed to each other through only press fitting or through only the adhesive. Also note that the shaft 31 and the rotor hub 33 may alternatively be fixed to each other by another method, such as, for example, shrink fitting.

The magnet 34 is fixed to an inner circumferential surface of the yoke 35, which will be described below, through, for example, an adhesive. A permanent magnet in the shape of a circular ring is used as the magnet 34 according to the present preferred embodiment. The magnet 34 is cylindrical or substantially cylindrical, and is arranged radially outside of the stator 22. An inner circumferential surface of the magnet 34 includes north and south poles arranged to alternate with each other in a circumferential direction. In addition, the inner circumferential surface of the magnet 34 is arranged radially opposite to a radially outer end surface of each of the teeth 412 with a slight gap therebetween. That is, the magnet 34 includes a pole surface arranged radially opposite to the stator 22. Note that a plurality of magnets may be used in place of the magnet 34 in the shape of a circular ring. In the case where the plurality of magnets are used, the magnets are arranged on the inner circumferential surface of the yoke 35 such that pole surfaces of the north poles and pole surfaces of the south poles alternate with each other in the circumferential direction.

The yoke 35 is a cylindrical member arranged to hold the magnet 34. An outer circumferential surface of the magnet 34 is fixed to the inner circumferential surface of the yoke 35. The yoke 35 is arranged to be substantially coaxial with the central axis 9. An upper end portion of the yoke 35 is fixed to a lower surface of a radially outer portion of the rotor hub 33 through an adhesive or by crimping, for example. A magnetic material, such as, for example, iron, is used as a material of the yoke 35. Use of the yoke 35 made of the magnetic material contributes to preventing magnetic flux generated from the magnet 34 from escaping outward.

Once electric drive currents are supplied to the coils 42 in the motor 10 described above, magnetic flux is generated around each of the teeth 412, which serve as magnetic cores for the coils 42. In addition, a magnetic circuit passing through the stator 22, the magnet 34, and the yoke 35 is defined. Then, interaction between the magnetic flux of the teeth 412 and magnetic flux of the magnet 34 produces a circumferential torque between the stationary portion 2 and the rotating portion 3, so that the rotating portion 3 is caused to rotate about the central axis 9 with respect to the stationary portion 2. The optical components 90 and the flywheel 8 are thus caused to rotate about the central axis 9 together with the rotating portion 3.

Next, the structures of the flywheel 8 and the optical components 90 will now be described below. The following description will be made with reference to FIGS. 1 to 3 appropriately.

The flywheel 8 is arranged below the light source 6 and above the motor 10, and is supported by an upper end portion of the rotating portion 3 of the motor 10. The flywheel 8 is fixed to an upper surface of the rotating portion 3 through, for example, engagement, an adhesive, or the like. In addition, the flywheel 8 is arranged to support each of the optical components 90, which include a mirror 61 and a lens 63. A resin, for example, is used as a material of the flywheel 8. Glass, for example, is used as materials of the mirror 61 and the lens 63. The glass is not limited to particular types of glass. For example, organic glass, inorganic glass, a resin, or a metal may be used as the materials of the mirror 61 and the lens 63, but other materials may alternatively be used.

The flywheel 8 includes a tubular portion 81, a hollow portion 82, and a lower support portion 83. The tubular portion 81 is a cylindrical member arranged to extend along the central axis 9. The hollow portion 82 is a cavity defined in the flywheel 8. In addition, a through hole 84, which is arranged to pass through the tubular portion 81 in the first radial direction D1, is defined in the tubular portion 81 at one circumferential position. The lens 63 or a lens frame (not shown), which is arranged to be in contact with a peripheral portion of the lens 63, is fitted and fixed in the through hole 84.

The lower support portion 83 is a portion of a lower portion of the flywheel 8, the portion lying inside of a peripheral portion of the lower portion of the flywheel 8. A lower surface of the lower support portion 83 defines at least a portion of a lower surface of the flywheel 8. The mirror 61 is fixed to a mirror support portion 831, which is defined integrally with an upper surface of the lower support portion 83. Note that the lower support portion 83 may include a cavity (not shown) defined on and around the central axis 9 of the motor 10 in a radially inner portion thereof. In addition, a portion of the incoming light 60 may pass through the mirror 61 and further travel downward through this cavity (not shown). In the present preferred embodiment, the tubular portion 81 and the lower support portion 83 are defined as a single monolithic member by a resin injection molding process. Note, however, that the tubular portion 81 and the lower support portion 83 may alternatively be defined by separate members.

The mirror 61 is in the shape of a plate, and is arranged to have a rectangular or circular external shape. The mirror 61 is fixed to a resin member of the flywheel 8, and at least a portion of the mirror 61 is arranged on the central axis 9. In addition, a reflecting surface of the mirror 61 is inclined at an angle of 45 degrees with respect to the axial direction and the first radial direction D1. A fully reflective mirror, for example, is used as the mirror 61. The incoming light 60 impinges on a central portion of the mirror 61. The central portion of the mirror 61 refers to the entire mirror 61, excluding a peripheral portion of the mirror 61. The incoming light 60 is reflected by the mirror 61 inside of the flywheel 8, and is changed in direction. Note that, instead of the mirror 61, a prism (not shown) or the like may alternatively be used to change the direction of the incoming light 60.

The lens 63 is in the shape of a plate, and is arranged to have a rectangular or circular external shape. The lens 63 is fixed in the through hole 84 through, for example, adhesion or engagement directly or through the lens frame (not shown) arranged to be in contact with at least a portion of the peripheral portion of the lens 63. In addition, the lens 63 is arranged at right angles to the first radial direction D1, that is, in parallel with the central axis 9, in a state in which the lens 63 is fixed to the flywheel 8. As suggested above, the incoming light 60 is reflected by the mirror 61 inside of the flywheel 8 to become the reflected light 62. The reflected light 62 passes through a central portion of the lens 63 to be emitted to an outside of the flywheel 8. The central portion of the lens 63 refers to the entire lens 63, excluding the peripheral portion of the lens 63.

The hollow portion 82, the mirror 61, and the lens 63 are arranged to overlap at least in part with each other when viewed in the first radial direction D1. Further, an upper surface of the flywheel 8 is provided with an opening 85. At least a portion of the flywheel 8 is exposed upwardly through the opening 85. The incoming light 60, which is emitted from the light source 6, comes from above the upper surface of the flywheel 8, passes through the opening 85, and travels downward along the central axis 9 in the hollow portion 82 radially inside of the tubular portion 81. Then, the incoming light 60 is reflected by the mirror to become the reflected light 62. The reflected light 62 further travels in the first radial direction D1 in the hollow portion 82, and is emitted to the outside of the rotary drive apparatus 1 through the lens 63 fitted in the through hole 84 of the tubular portion 81.

The mirror 61 of the flywheel 8 is arranged to reflect the incoming light 60 coming from the light source 6 and emit the reflected light 62 to the outside of the rotary drive apparatus 1 while rotating about the central axis 9 together with the rotating portion 3 of the motor 10. Thus, a wide range can be irradiated with light. Note that the rotation speed of the rotary drive apparatus 1 can be recognized by sensing the reflected light 62, which is emitted out of the flywheel 8, using an external sensor (not shown). In addition, an outer circumferential surface of the flywheel 8 has a reflectivity lower than that of a front surface of the mirror 61. This contributes to preventing diffuse reflection of the incoming light 60 coming from the light source 6.

Note that the rotary drive apparatus 1 may further include, in addition to the flywheel 8 arranged to emit the reflected light 62 to the outside in the first radial direction D1, another flywheel (not shown) which is arranged to emit reflected light to the outside in a second radial direction different from the first radial direction D1, and which is arranged, for example, below the motor 10. In this case, a half mirror the transmissivity and reflectivity of which are substantially equal is used as the mirror 61. Then, a half of the incoming light 60 which impinges on the mirror 61 in the flywheel 8 is reflected in the first radial direction D1 to be emitted to the outside. In addition, a remaining half of the incoming light 60 which impinges on the mirror 61 passes through the mirror 61, and travels downward through the aforementioned cavity (not shown) defined on and around the central axis 9 in the radially inner portion of the lower support portion 83. In addition, a through hole (not shown) passing through the motor 10 in the axial direction is defined around the central axis 9 in the motor 10. Thus, the portion of the incoming light 60 which has passed through the mirror 61 passes through the through hole and reaches the other flywheel arranged below the motor 10. Then, in the other flywheel, all the remaining half of the incoming light 60 is reflected in the second radial direction, using a fully reflective mirror (not shown), to be emitted to the outside. Note that a plurality of mirrors (not shown), including a half mirror, which are arranged to reflect the incoming light 60 in mutually different directions may alternatively be installed in the single flywheel 8 of the rotary drive apparatus 1.

When light is emitted out in the two different directions, i.e., the first radial direction D1 and the second radial direction, as described above, light beams that are emitted out in the two different directions take different times to reach an object to be irradiated with light while the motor 10 is rotating, and this makes it possible to precisely recognize the three-dimensional position of the object in a space. Note that the other flywheel may alternatively be arranged in a rotary drive apparatus (not shown) other than the rotary drive apparatus 1 including the flywheel 8.

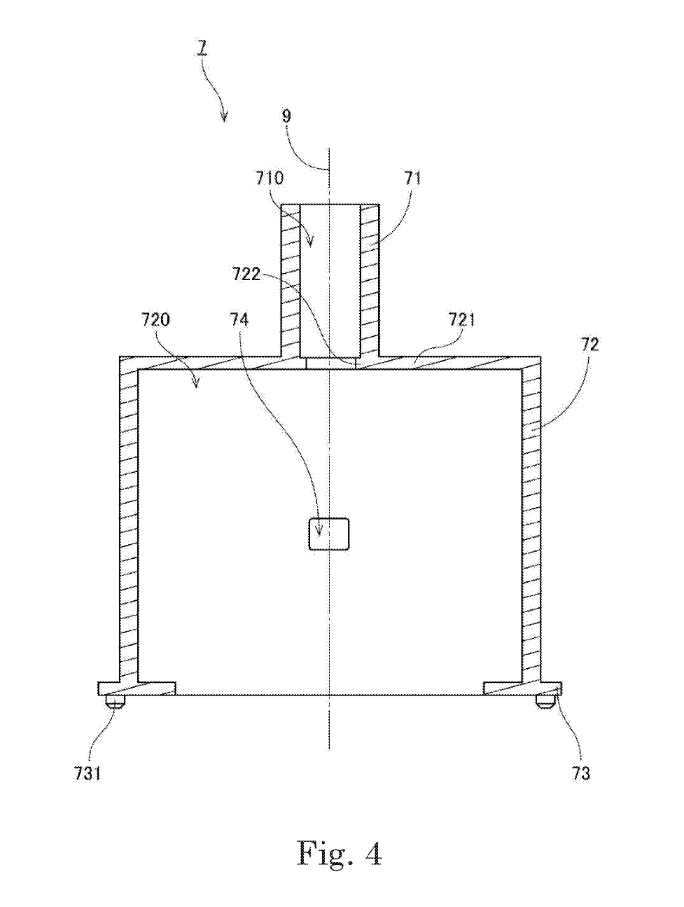

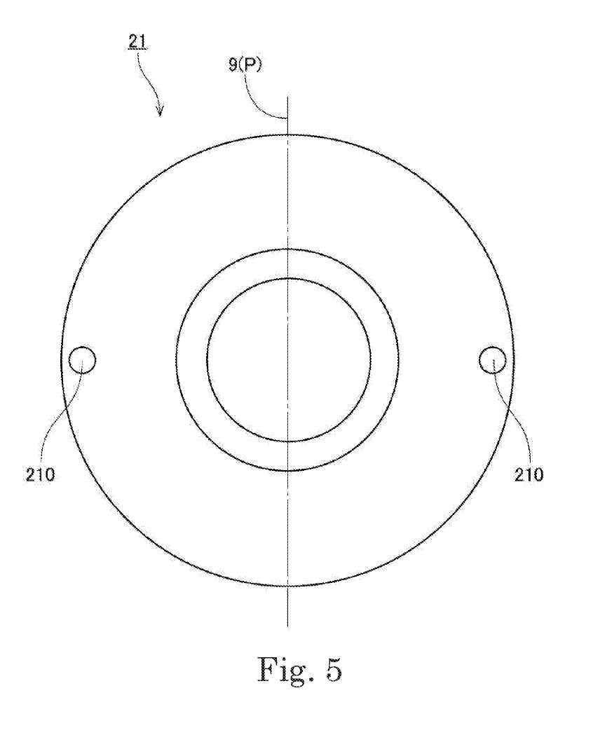

Next, the structure of the housing 7 and structures by which the light source 6 and the rotary drive apparatus 1 are fixed to the housing 7 will now be described below. Hereinafter, reference will be made to FIGS. 1 to 3 appropriately as well as FIGS. 4 and 5, which will be described below.

FIG. 4 is a vertical sectional view of the housing 7 according to the first preferred embodiment. The housing 7 includes at least one tubular portion extending along the central axis 9. In addition, as suggested above, at least a portion of each optical component 90 and at least a portion of the rotary drive apparatus 1, which includes the motor 10 arranged to rotate the optical components 90, are housed in the housing 7. A resin or a metal, for example, is used as a material of the housing 7. Use of the resin allows the housing 7 to be molded easily and at a low cost. Meanwhile, use of the metal leads to an improvement in dimensional accuracy of the housing 7. Referring to FIG. 4, the housing 7 includes the first tubular portion 71 and a second tubular portion 72.

The first tubular portion 71 is a tubular portion arranged to extend along the central axis 9. The first tubular portion 71 has a first cavity 710, which is a cavity defined radially inside of the first tubular portion 71. At least a portion of the light source 6 is housed in the first cavity 710. In addition, the first cavity 710 is connected to a second cavity 720, which is a cavity defined radially inside of the second tubular portion 72, which will be described below. Further, each of the first cavity 710 and the second cavity 720, which will be described below, includes a light path along which the incoming light 60 travels.

Reference is made again to FIG. 3. The first tubular portion 71 includes one or more first through holes 91 each of which is arranged to pass through the first tubular portion 71 in a radial direction at at least one circumferential position. In addition, the light source 6 includes one or more holes 92 each of which is recessed radially inward from at least a portion of an outer circumferential surface of the light source 6. Then, each of one or more screws 93, each of which is arranged to pass through a corresponding one of the one or more first through holes 91, is further inserted into a corresponding one of the one or more holes 92, so that the light source 6 is positioned with respect to the first tubular portion 71, and is fixed to the first tubular portion 71. Thus, one or more light source positioning portions, each of which is arranged to be in radial contact with the light source 6 through the corresponding screw 93, are defined in the first tubular portion 71 at at least one axial position. Note that the first tubular portion 71 according to the present preferred embodiment includes only one first through hole 91. In addition, the outer circumferential surface of the light source 6 is positioned with respect to the first tubular portion 71, and is fixed to the first tubular portion 71, through only one screw 93 arranged to pass through the one first through hole 91 at at least one circumferential position. This leads to a reduced number of parts and a reduced cost.

In addition, the housing 7 further includes a housing annular portion 711 being annular and arranged to project radially inward from at least a portion of an inner circumferential surface of the first tubular portion 71 or a flat portion 721, which will be described below. A lower surface of the light source 6 is arranged to be in contact with the housing annular portion 711, and is thus axially positioned. That is, a second light source positioning portion, which is arranged to be in axial contact with the light source 6, is defined by the housing annular portion 711. Note that the housing annular portion 711 does not block the progress of the incoming light 60 coming from the light source 6. Also note that the housing annular portion 711 may be arranged to project radially inward from the entire inner circumferential surface of the flat portion 721, which will be described below, or the first tubular portion 71, and that a plurality of such housing annular portions 711 may alternatively be arranged to project radially inward from a plurality of positions in the inner circumferential surfaces of the first tubular portion 71 and the flat portion 721, which will be described below.

Further, the light source 6 according to the present preferred embodiment includes a light source press fit portion 94 fixed to the first tubular portion 71 through press fitting. That is, the light source 6 is housed in the first tubular portion 71, and is at the same time fixed to the inner circumferential surface of the first tubular portion 71 through press fitting. This contributes to preventing a displacement of the light source 6. In addition, the light path along which the incoming light 60 coming from the light source 6 travels can thus be maintained with high precision. As a result, an increased product reliability can be achieved.

Next, the structure of the second tubular portion 72 and the structure by which the rotary drive apparatus 1 is fixed to the housing 7 will now be described below. Referring to FIG. 4, the second tubular portion 72 is a portion being tubular, arranged to extend along the central axis 9, and arranged below the first tubular portion 71. The second tubular portion 72 is arranged to have a diameter greater than that of the first tubular portion 71. In the present preferred embodiment, the housing 7 further includes the flat portion 721, which is arranged to join an upper end portion of the second tubular portion 72 and a lower end portion of the first tubular portion 71 to each other. At least a portion of each optical component 90 and at least a portion of the rotary drive apparatus 1 are housed below the flat portion 721 and inside of the second tubular portion 72.

The housing 7 further includes a housing bottom portion 73 arranged to extend radially outward from at least a portion of a lower end portion of the second tubular portion 72. The housing bottom portion 73 is arranged to extend radially outward from a portion of the lower end portion of the second tubular portion 72 which does not axially overlap with an opening portion 70, which will be described below. Note that the housing bottom portion 73 may include a portion arranged to extend radially inward from at least a portion of the lower end portion of the second tubular portion 72. In this case, this portion can be used to fix the housing 7 to the base portion 21.

The housing bottom portion 73 includes one or more projecting portions 731 each of which is arranged to project downward from a portion of a lower surface thereof. FIG. 5 is a top view of the base portion 21 of the motor 10 according to the first preferred embodiment. As described above, the base portion 21 includes the one or more recessed portions 210 each of which is recessed downward from a portion of the upper surface of the base portion 21. Then, each of the one or more projecting portions 731 of the housing bottom portion 73 is fitted into a corresponding one of the one or more recessed portions 210 of the base portion 21. Thus, one or more motor positioning portions, each of which is arranged to be in axial contact with the motor 10, are defined in the housing 7 at at least one axial position. Note that the base portion 21 may alternatively include one or more second through holes (not shown) each of which is arranged to pass through the base portion 21 in the axial direction, instead of the one or more recessed portions 210 each of which is recessed downward from a portion of the upper surface of the base portion 21. Further, at least a portion of the rotary drive apparatus 1, including the base portion 21, may be fixed to the second tubular portion 72 through press fitting, adhesion, fitting, engagement, or the like, in addition to the projecting portion(s) 731 of the housing bottom portion 73 being fitted into the recessed portion(s) 210 of the base portion 21. This contributes to preventing a displacement of the rotary drive apparatus 1 including the optical components 90, and maintaining the light path along which the incoming light 60 coming from the light source 6 travels with high precision. As a result, an increased product reliability can be achieved.

As suggested above, in the present preferred embodiment, the housing 7, which includes the first tubular portion 71, the second tubular portion 72, the housing bottom portion 73, the aforementioned light source positioning portion(s) arranged to position the light source 6 with respect to the first tubular portion 71, and the aforementioned motor positioning portion(s) arranged to position the rotary drive apparatus 1 with respect to the second tubular portion 72, is defined by a single monolithic member. This allows the housing 7 to be molded using a single mold, which enables a reduction in a production cost of the housing 7. Moreover, the light source 6 and the rotary drive apparatus 1, which includes the flywheel 8 arranged to support the optical components 90 and the motor 10 arranged to rotate the flywheel 8, are positioned using the housing 7 defined by a single monolithic member. Thus, a reduction in the number of parts and a reduction in a production cost of the housing unit 4 can be achieved. Further, an improvement in workability in assembling, and an increase in efficiency in manufacturing the housing unit 4 can be achieved. Furthermore, a reduction in the likelihood of a displacement of the incoming light 60 coming from the light source 6 and a reduction in the likelihood of a displacement of each optical component 90 can be achieved, which contributes to maintaining the light path along which the incoming light 60 coming from the light source 6 travels with high precision, and thus increasing the product reliability.

Here, reference is made again to FIGS. 1 and 3. The second tubular portion 72 has the opening portion 70 defined at at least one circumferential position. In the present preferred embodiment, about a circumferential half of a side surface of the rotary drive apparatus 1 is exposed to the opening portion 70. The incoming light 60 coming from the light source 6 travels downward along the central axis 9, and enters from above into the flywheel 8 through the first cavity 710 and the second cavity 720. Then, the reflected light 62, which has been reflected by the mirror 61, travels outward in the first radial direction D1, and is emitted to the outside of the rotary drive apparatus 1 through the lens 63 and the opening portion 70. The aforementioned recessed portions 210 or the aforementioned second through holes (not shown) are arranged symmetrically with respect to a plane P (see FIGS. 1 and 5) including the central axis 9 and passing through a circumferential middle of the opening portion 70. In addition, at least two of the projecting portions 731 are arranged symmetrically with respect to the central axis 9. Thus, the rotary drive apparatus 1, including the base portion 21, can be fixed to the housing 7 in a well-balanced manner.

Referring to FIGS. 3 and 4, the second tubular portion 72 includes a third through hole 74 arranged to pass therethrough in a radial direction at a position different from that of the opening portion 70 of the second tubular portion 72. At least a portion of the rotating portion 3 of the motor 10 is exposed to an outside of the housing 7 through the third through hole 74. If infrared rays, light beams, or the like are emitted toward the third through hole 74 from the outside of the housing 7, for example, when the rotating portion 3 is rotating while the rotary drive apparatus 1 is running, the infrared rays, the light beams, or the like are reflected by an exposed portion of the rotating portion 3. Then, the rotation speed of the rotary drive apparatus 1 can be recognized by sensing the reflected infrared rays, light beams, or the like with an infrared sensor, a photoelectric sensor, or the like (not shown) arranged outside of the housing 7. Note that the third through hole 74 is defined in, for example, a surface of the housing 7 which is opposite to the opening portion 70. Note, however, that the third through hole 74 may alternatively be defined at any other desirable position.

While a preferred embodiment of the present invention has been described above, it will be understood that the present invention is not limited to the above-described preferred embodiment.

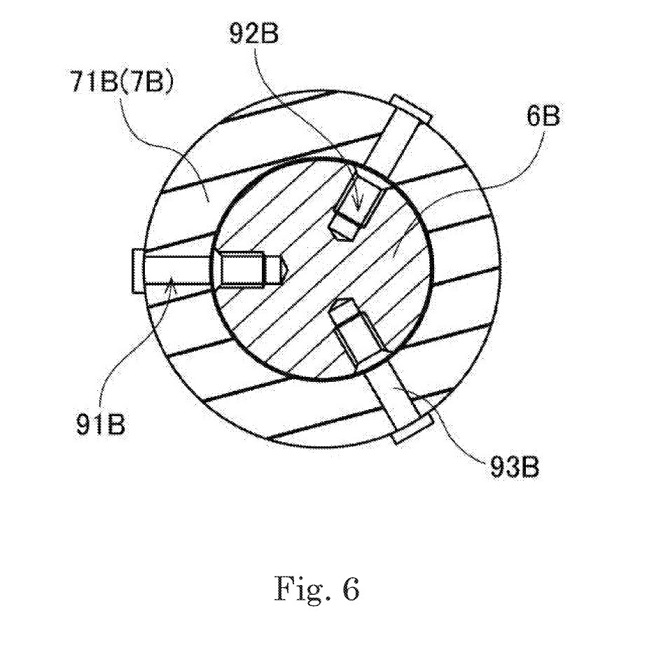

FIG. 6 is a horizontal sectional view of a light source 6B and a first tubular portion 71B of a housing 7B according to a modification of the first preferred embodiment. In the modification illustrated in FIG. 6, the first tubular portion 71B includes three first through holes 91B each of which is arranged to pass through the first tubular portion 71B in a radial direction at at least one circumferential position. The three first through holes 91B are arranged at regular intervals in a circumferential direction of the first tubular portion 71B. In addition, the light source 6B includes three holes 92B each of which is recessed radially inward from at least a portion of an outer circumferential surface of the light source 6B. Then, each of three screws 93B, each of which is arranged to pass through a corresponding one of the three first through holes 91B, is further inserted into a corresponding one of the three holes 92B, so that the light source 6B is positioned with respect to the first tubular portion 71B, and is fixed to the first tubular portion 71B. Thus, a displacement of the light source 6B can be more effectively prevented. As a result, a light path along which incoming light coming from the light source 6B travels can be maintained with high precision, which leads to an additional increase in product reliability.

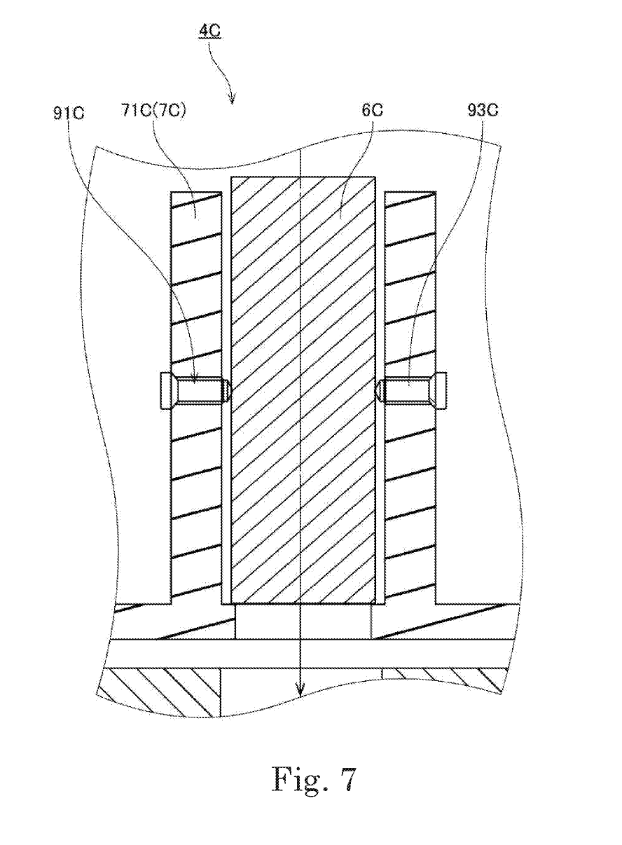

FIG. 7 is a partial vertical sectional view of a housing unit 4C according to another modification of the first preferred embodiment. In the modification illustrated in FIG. 7, a first tubular portion 71C of a housing 7C includes one or more first through holes 91C each of which is arranged to pass through the first tubular portion 71C in a radial direction at at least one circumferential position. Then, a light source 6C is positioned with respect to the first tubular portion 71C, and is fixed to the first tubular portion 71C, through one or more screws 93C each of which is arranged to pass through a corresponding one of the one or more first through holes 91C. Notice that an outer circumferential surface of the light source 6C does not include a hole recessed radially inward. Thus, the light source 6C can be fixed to the first tubular portion 71C without a hole being defined in the light source 6C. Thus, a reduction in the number of working processes to be performed on the light source 6C is achieved, which leads to increased manufacturing efficiency.

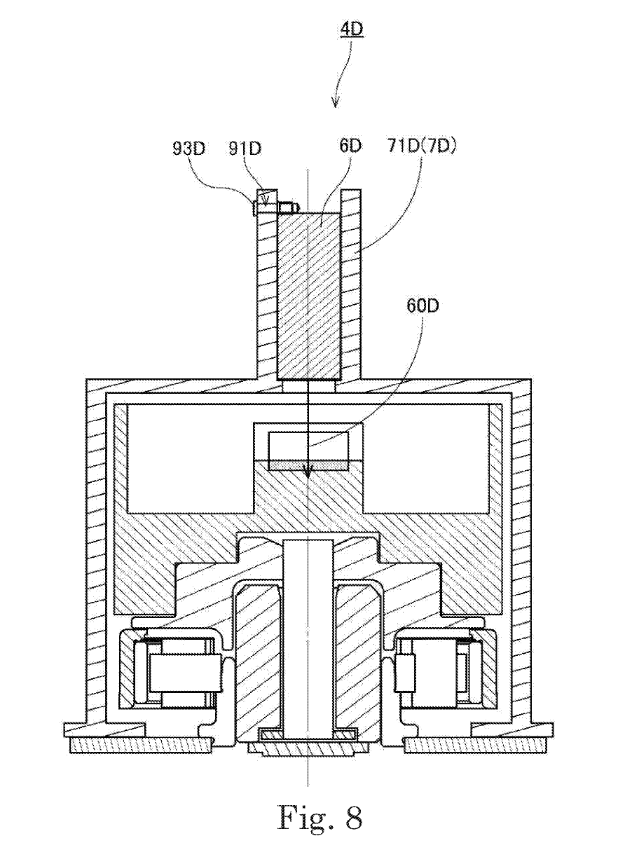

FIG. 8 is a vertical sectional view of a housing unit 4D according to yet another modification of the first preferred embodiment. In the modification illustrated in FIG. 8, a first tubular portion 71D of a housing 7D includes one first through hole 91D arranged to pass through the first tubular portion 71D in a radial direction at at least one circumferential position. Then, at least a portion of an upper surface of a light source 6D is fixed with respect to the first tubular portion 71D through one screw 93D arranged to pass through the one first through hole 91D. Thus, a reduction in the number of working processes to be performed on the light source 6D is achieved, which leads to increased manufacturing efficiency.

Note that, in the modification illustrated in FIG. 8, the number of first through holes 91D and the number of screws 93D to be arranged to pass through the first through holes 91D are not limited. For example, the first tubular portion 71D may alternatively include three first through holes 91D arranged at regular intervals in a circumferential direction of the first tubular portion 71D. In addition, the upper surface of the light source 6D may alternatively be fixed with respect to the first tubular portion 71D through three screws 93D each of which is arranged to pass through a corresponding one of the three first through holes 91D. Thus, a displacement of the light source 6D can be more effectively prevented. As a result, a light path along which incoming light 60D coming from the light source 6D travels can be maintained with high precision, which leads to an additional increase in product reliability.

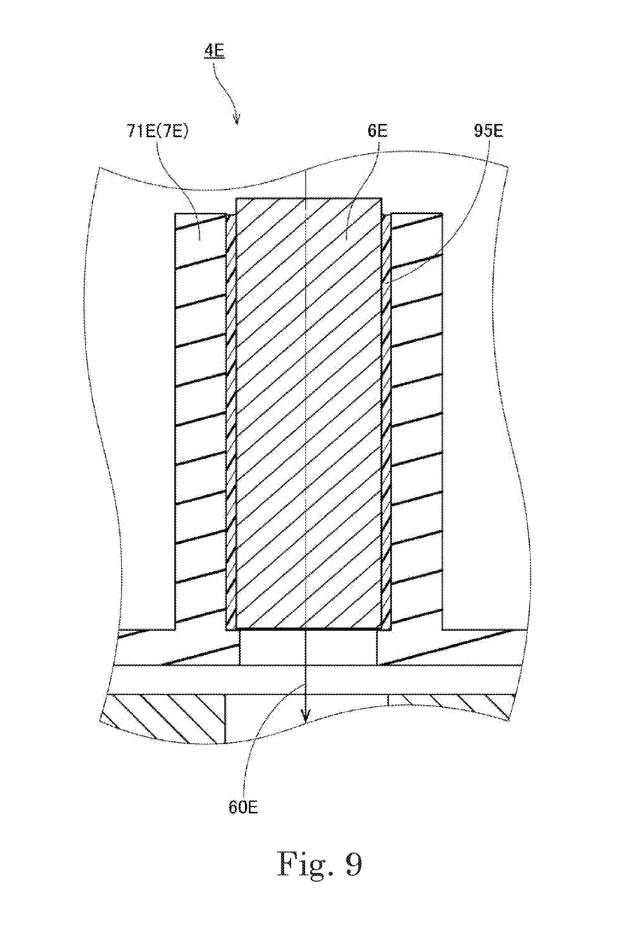

FIG. 9 is a partial vertical sectional view of a housing unit 4E according to yet another modification of the first preferred embodiment. In the modification illustrated in FIG. 9, a light source 6E includes a light source adhesion portion 95E fixed to a first tubular portion 71E of a housing 7E through adhesion. That is, the light source 6E is fixed to an inner circumferential surface of the first tubular portion 71E through adhesion when the light source 6E is housed in the first tubular portion 71E. This contributes to preventing a displacement of the light source 6E, and maintaining a light path along which incoming light 60E coming from the light source 6E travels with high precision, and thus, an increased product reliability can be achieved.

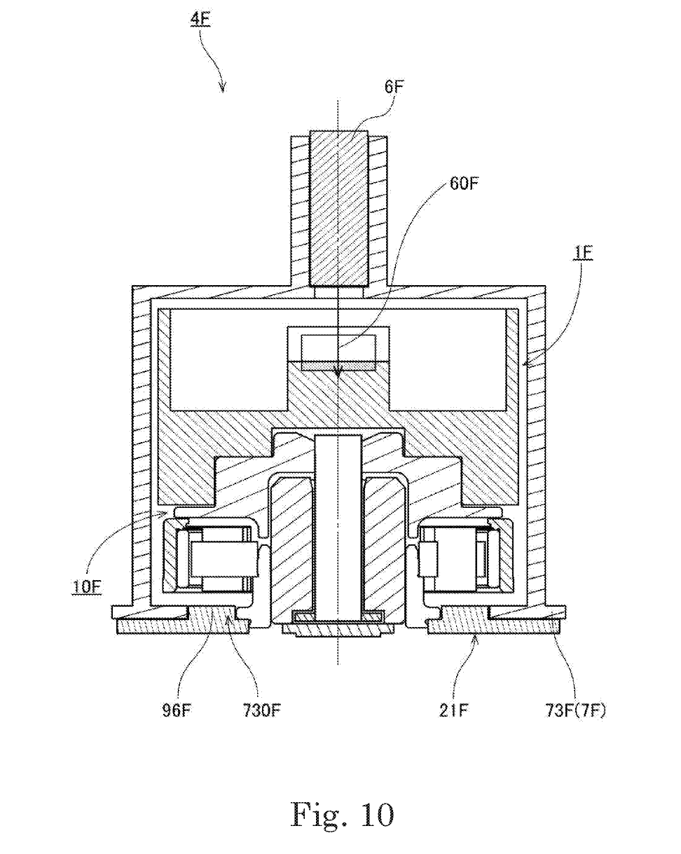

FIG. 10 is a vertical sectional view of a housing unit 4F according to yet another modification of the first preferred embodiment. In the modification illustrated in FIG. 10, a base portion 21F of a motor 10F includes a motor fitting portion 96F arranged to project upward from a portion of an upper surface of the base portion 21F. The motor fitting portion 96F is fixed to a housing bottom portion 73F of a housing 7F through fitting. Accordingly, the radial position of an outer circumferential surface of the motor fitting portion 96F substantially coincides with the radial position of an inner circumferential surface of the housing bottom portion 73F. Then, the motor fitting portion 96F is fitted in a cavity 730F radially inside of the housing bottom portion 73F. This contributes to preventing a displacement of the rotary drive apparatus 1F, and maintaining a light path along which incoming light 60F coming from a light source 6F travels with high precision, and thus, an increased product reliability can be achieved.

In the above-described preferred embodiment, the light source positioning portions are arranged to be in contact with the light source in the radial direction and the axial direction. Note, however, that it may be sufficient if the light source positioning portion(s) is arranged to be in contact with the light source in at least one of the axial direction, the radial direction, and the circumferential direction, and that the light source positioning portion(s) is not limited in shape or orientation. Meanwhile, in the above-described preferred embodiment, the motor positioning portions are arranged to be in contact with the motor in the axial direction. Note, however, that it may be sufficient if the motor positioning portion(s) is arranged to be in contact with the motor in at least one of the axial direction, the radial direction, and the circumferential direction, and that the motor positioning portion(s) is not limited in shape or orientation.

Note that the detailed shape of any member may be different from the shape thereof as illustrated in the accompanying drawings of the present application. Also note that features of the above-described preferred embodiments and the modifications thereof may be combined appropriately as long as no conflict arises.

Preferred embodiments of the present invention are applicable to, for example, housings and housing units.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A housing arranged to house therein at least a portion of an optical component and at least a portion of a rotary drive apparatus, the optical component being arranged to reflect incoming light coming from a light source or allow the incoming light to pass therethrough, the rotary drive apparatus including a motor arranged to rotate the optical component, the housing including at least one tubular portion extending along a central axis extending in a vertical direction, the housing comprising at at least one axial position:
one or more light source positioning portions each of which is arranged to be in contact with the light source in at least one of an axial direction, a radial direction, and a circumferential direction; and
one or more motor positioning portions each of which is arranged to be in contact with the motor in at least one of the axial direction, the radial direction, and the circumferential direction; wherein
the housing is defined by a single monolithic member including the one or more light source positioning portions and the one or more motor positioning portions; and
a cavity radially inside of the housing includes a light path along which the incoming light travels.

2. A housing unit comprising the housing of claim 1, the light source, and the rotary drive apparatus, wherein
the housing includes:
a first tubular portion being tubular and arranged to extend along the central axis; and
a second tubular portion being tubular, arranged to extend along the central axis, and arranged below the first tubular portion;
the second tubular portion is arranged to house therein at least a portion of the optical component;
the first tubular portion, the second tubular portion, the one or more light source positioning portions, and the one or more motor positioning portions are defined by a single monolithic member; and
the light source includes a light source press fit portion fixed to the first tubular portion through press fitting.

3. A housing unit comprising the housing of claim 1, the light source, and the rotary drive apparatus, wherein
the housing includes:
a first tubular portion being tubular and arranged to extend along the central axis; and
a second tubular portion being tubular, arranged to extend along the central axis, and arranged below the first tubular portion;
the second tubular portion is arranged to house therein at least a portion of the optical component;
the first tubular portion, the second tubular portion, the one or more light source positioning portions, and the one or more motor positioning portions are defined by a single monolithic member; and
the light source includes a light source adhesion portion fixed to the first tubular portion through adhesion.

4. A housing unit comprising the housing of claim 1, the light source, and the rotary drive apparatus, wherein
the housing includes:
a first tubular portion being tubular and arranged to extend along the central axis; and
a second tubular portion being tubular, arranged to extend along the central axis, and arranged below the first tubular portion;
the second tubular portion is arranged to house therein at least a portion of the optical component;
the first tubular portion, the second tubular portion, the one or more light source positioning portions, and the one or more motor positioning portions are defined by a single monolithic member;
the first tubular portion includes one or more first through holes each of which is arranged to pass through the first tubular portion in the radial direction at at least one circumferential position; and
the light source is fixed to the first tubular portion through one or more screws each of which is arranged to pass through a corresponding one of the one or more first through holes.

5. The housing unit according to claim 4, wherein
the first tubular portion includes only one of the first through holes; and
the light source is fixed to the first tubular portion through only one of the screws arranged to pass through the one first through hole.

6. The housing unit according to claim 4, wherein
the first tubular portion includes three of the first through holes;
the three first through holes are arranged at regular intervals in a circumferential direction of the first tubular portion; and
the light source is fixed to the first tubular portion through three of the screws each of which is arranged to pass through a corresponding one of the three first through holes.

7. The housing unit according to claim 4, wherein
the first tubular portion includes only one of the first through holes; and
at least a portion of an upper surface of the light source is fixed with respect to the first tubular portion through only one of the screws arranged to pass through the one first through hole.

8. The housing unit according to claim 4, wherein
the first tubular portion includes three of the first through holes;
the three first through holes are arranged at regular intervals in a circumferential direction of the first tubular portion; and
at least a portion of an upper surface of the light source is fixed with respect to the first tubular portion through three of the screws each of which is arranged to pass through a corresponding one of the three first through holes.

9. A housing unit comprising the housing of claim 1, the light source, and the rotary drive apparatus, wherein
the housing includes:
a first tubular portion being tubular and arranged to extend along the central axis; and
a second tubular portion being tubular, arranged to extend along the central axis, and arranged below the first tubular portion;
the second tubular portion is arranged to house therein at least a portion of the optical component;
the first tubular portion, the second tubular portion, the one or more light source positioning portions, and the one or more motor positioning portions are defined by a single monolithic member;
the housing further includes a housing annular portion being annular and arranged to project radially inward from at least a portion of an inner circumferential surface of the first tubular portion; and
the housing annular portion defines one of the one or more light source positioning portions, and is arranged to be in axial contact with a lower surface of the light source.

10. A housing unit comprising the housing of claim 1, the light source, and the rotary drive apparatus, wherein
the housing includes:
a first tubular portion being tubular and arranged to extend along the central axis;
a second tubular portion being tubular, arranged to extend along the central axis, and arranged below the first tubular portion; and
a housing bottom portion arranged to extend radially outward from at least a portion of a lower end portion of the second tubular portion;
the second tubular portion is arranged to house therein at least a portion of the optical component;
the first tubular portion, the second tubular portion, the housing bottom portion, the one or more light source positioning portions, and the one or more motor positioning portions are defined by a single monolithic member;
the housing bottom portion includes a plurality of projecting portions each of which is arranged to project downward from a portion of a lower surface thereof;
the motor includes a stator and a base portion arranged to hold the stator;
the base portion includes a plurality of recessed portions or second through holes each of which is recessed downward from a portion of an upper surface thereof; and
each projecting portion is arranged to be fitted into the corresponding recessed portion or second through hole.

11. The housing unit according to claim 10, wherein
the second tubular portion has an opening portion defined at at least one circumferential position;
the optical component is arranged to reflect the incoming light;
the opening portion is arranged to allow reflected light resulting from the reflection of the incoming light by the optical component to be emitted to an outside of the rotary drive apparatus therethrough; and
at least two of the projecting portions are arranged symmetrically with respect to a plane including the central axis and passing through a circumferential middle of the opening portion.

12. The housing unit according to claim 11, wherein the housing bottom portion is arranged to extend radially outward from a portion of the lower end portion of the second tubular portion which does not axially overlap with the opening portion.

13. The housing unit according to claim 10, wherein
the second tubular portion has an opening portion defined at at least one circumferential position;
the optical component is arranged to reflect the incoming light;
the opening portion is arranged to allow reflected light resulting from the reflection of the incoming light by the optical component to be emitted to an outside of the rotary drive apparatus therethrough; and
the recessed portions or the second through holes are arranged symmetrically with respect to a plane including the central axis and passing through a circumferential middle of the opening portion.

14. A housing unit comprising the housing of claim 1, the light source, and the rotary drive apparatus, wherein
the housing includes:
a first tubular portion being tubular and arranged to extend along the central axis;
a second tubular portion being tubular, arranged to extend along the central axis, and arranged below the first tubular portion; and
a housing bottom portion arranged to extend radially outward from at least a portion of a lower end portion of the second tubular portion;
the second tubular portion is arranged to house therein at least a portion of the optical component;
the first tubular portion, the second tubular portion, the housing bottom portion, the one or more light source positioning portions, and the one or more motor positioning portions are defined by a single monolithic member; and
the motor includes a motor fitting portion fixed to the housing bottom portion through fitting.

15. The housing according to claim 1, wherein the housing is made of a resin.

16. The housing according to claim 1, wherein the housing is made of a metal.
